(19) United States
(12) Patent Application Publication
(10) Pub. No.: US 2025/0085155 A1
(43) Pub. Date: Mar. 13, 2025

(54) METHODS AND SYSTEMS FOR DETERMINING REAL-TIME EMISSIONS SAVINGS

(71) Applicant: Vanzandt Controls, LLC, Odessa, TX (US)

(72) Inventors: Don Maness, Fort Worth, TX (US); Brad Tipps, Fort Worth, TX (US)

(73) Assignee: Vanzandt Controls, LLC, Odessa, TX (US)

(21) Appl. No.: 18/824,013

(22) Filed: Sep. 4, 2024

Related U.S. Application Data
(60) Provisional application No. 63/536,981, filed on Sep. 7, 2023.

(51) Int. Cl. G01F 25/10; G01F 1/34; G01F 1/684

(52) U.S. Cl. CPC G01F 25/15; G01F 1/34; G01F 1/684

(57) ABSTRACT

The present disclosure provides systems and methods for determining, in real-time, emissions savings. The systems and methods are configured to determine emissions savings achieved by converting natural gas-powered pneumatic control systems to compressed instrument air systems. An amount of methane and/or carbon emissions savings is determined by calculating, in real-time, the amount of compressed air used by a pneumatic system and converting the amount of compressed air into an equivalent amount of methane and/or carbon emissions that would have been emitted into the atmosphere had the pneumatic system been operated by natural gas and/or electric power.

### CROSS-REFERENCE TO RELATED APPLICATIONS

This application claims the benefit of and priority to U.S. Provisional Application No. 63/536,981, filed on Sep. 7, 2023, and entitled “Methods and Systems for Determining Real-Time Emissions Savings,” the disclosure of which is expressly incorporated by reference in its entirety.

### TECHNICAL FIELD

The present invention relates generally to methods and systems for determining and calculating, in real-time, emissions savings achieved by converting natural gas-powered pneumatic control systems to compressed instrument air systems.

### BACKGROUND

Pneumatic devices are widely used in the oil and gas industry. The three main types of pneumatic devices used in the oil and gas industry are pneumatic controllers, which control conditions such as levels, temperatures, and pressure, pneumatic pumps/valves, which inject chemicals into wells and pipelines or circulate dehydrator fluids, and pneumatic valve actuators. These pneumatic devices are powered by gas pressure and are mainly used where electrical power is not available. For instance, FIG. 1 depicts a traditional wellhead system 50 having a pneumatic control system powered by natural gas. The pneumatic control system includes process control instruments and valves that are operated by natural gas. As shown in FIG. 1, a main supply line 1 uses a natural gas byproduct of oil to pressurize and activate valves 2. The valves 2 are powered and controlled by natural gas pressure from the main supply line 1.

While pneumatic devices are essential to the oil and gas industry, these devices, when powered using natural gas, can be one of the largest sources of methane emissions in petroleum and natural gas supply chains. Because these pneumatic devices are powered by natural gas, they emit methane and other pollution upon actuation. Methane emissions are harmful to the environment and can be more potent than carbon dioxide in trapping heat in the atmosphere. Indeed, methane is a much more potent warming agent than carbon dioxide, trapping 87 times more heat in the earth's atmosphere in the first twenty years after it is released (on a pound-for-pound basis).

The recently enacted Inflation Reduction Act (IRA) contains several new provisions related to methane emissions impacting oil and gas companies. Companies who already report emissions to the U.S. Environmental Protection Agency's (EPA) Greenhouse Gas Emissions Reporting Program under the Clean Air Act are likely to face stiff new charges starting in 2025, unless they reduce their emissions below the 25,000 metric tons of carbon dioxide equivalent threshold. Central to the new “Methane Emissions Reduction Program” in the IRA is the methane emissions charge, which the IRA authorizes the EPA to collect from certain entities in the oil and natural gas sector starting in 2024. The methane emissions charge will start at $900 per metric ton of methane emitted in 2024 and increase to $1,200 in 2025 and $1,500 in 2026. As such, there is an ever-increasing focus by oil and gas producers to reduce methane emissions through the development of new technologies and processes.

Methods of reducing methane emissions from pneumatic devices range from preventing emissions, to reducing emissions, to repairing those devices with emissions that are higher than expected. For example, to reduce methane and carbon emissions, many companies have converted their natural gas-powered pneumatic control systems to compressed instrument air systems. Instrument air systems substitute compressed air for the pressurized natural gas, eliminating methane emissions and providing additional safety benefits.

While instrument air systems provide significant economic and environmental benefits, there is currently no way to determine how much methane and/or carbon emissions were prevented from entering the atmosphere by converting the natural gas-powered pneumatic control systems to compressed instrument air systems. Accordingly, there remains a need in the art for a method and system for calculating, in real-time, methane and/or carbon emissions savings achieved by converting natural gas-powered pneumatic control systems to compressed instrument air systems.

### SUMMARY

The problems expounded above, as well as others, are addressed by the following inventions, although it is to be understood that not every embodiment of the inventions described herein will address each of the problems described above.

In some embodiments, a system for determining methane emissions savings from operating a compressed air-powered pneumatic system is provided, the system including an air compressor configured to transmit air through a conduit; a flow measurement device operatively connected to the conduit, wherein the flow measurement device is configured to measure a flow rate of the air transmitted by the air compressor; a controller operatively connected to the air compressor and the flow measurement device, wherein the controller includes software configured to calculate, in real time, a compensated air flow volume based on the measured flow rate and at least one or both of a temperature measurement or a pressure measurement of the air; convert the compensated air flow volume to a methane emissions output quantity; and generate, using the methane emissions output quantity, a quantity of methane emissions savings. In one embodiment, the controller is a programmable logic controller (PLC), a remote telemetry unit (RTU), a flow computer, or any combination thereof. In another embodiment, the flow measurement device is a flow meter. In still another embodiment, the controller is configured to calculate the compensated air flow volume based on effects associated with Boyle's Law, Charles' Law, or both. In yet another embodiment, the system further includes a pressure sensor operatively connected to the air compressor and the controller, wherein the pressure sensor is configured to transmit the pressure measurement of the air to the controller. In still another embodiment, the system further includes a temperature sensor operatively connected to the conduit and the controller, wherein the temperature sensor is configured to transmit the temperature measurement of the air to the controller.

In further embodiments, a system for determining methane and carbon emissions savings from operating a solar-powered compressed air pneumatic system is provided, the system including an air compressor configured to transmit air through a conduit, wherein the air compressor is powered by solar energy; a flow measurement device operatively connected to the conduit, wherein the flow measurement device is configured to measure a flow rate of the air transmitted by the air compressor; a controller operatively connected to the air compressor and the flow measurement device, wherein the controller is configured to calculate, in real time, (i) a compensated air flow volume based on the measured flow rate and at least one or both of a temperature measurement or a pressure measurement of the air, and (ii) a solar power output; and a computing device communicatively coupled to the controller, wherein the computing device includes emissions tracking software configured to convert the compensated air flow volume to an equivalent methane emissions output quantity; convert the solar power output to an equivalent carbon emissions output quantity; and generate, using the equivalent methane and carbon emissions output quantities, a quantity of methane emissions savings and a quantity of carbon emissions savings. In one embodiment, the controller is a programmable logic controller (PLC), a remote telemetry unit (RTU), a flow computer, or any combination thereof. In another embodiment, the flow measurement device is a flow meter. In still another embodiment, the system further includes a pressure sensor operatively connected to the air compressor and the controller, wherein the pressure sensor is configured to transmit the pressure measurement of the air to the controller. In yet another embodiment, the system further includes a temperature sensor operatively connected to the conduit and the controller, wherein the temperature sensor is configured to transmit the temperature measurement of the air to the controller. In still another embodiment, the system further includes a human-machine interface (HMI) operatively connected to the controller, the computing device, or both.

In still further embodiments, a method for determining methane emissions savings from operating a compressed air-powered pneumatic system is provided, the method including measuring a flow rate of air transmitted by an air compressor; calculating a compensated air flow volume based on the measured flow rate and at least one or both of a temperature measurement or a pressure measurement of the air; transmitting the compensated air flow volume to a computing device, wherein the computing device includes emissions tracking software configured to convert the compensated air flow volume to an equivalent methane emissions output quantity; and generate, using the methane emissions output quantity, a quantity of methane emissions savings. In one embodiment, the measuring step is performed with a flow meter. In another embodiment, the calculating step is performed with a controller comprising a programmable logic controller (PLC), a remote telemetry unit (RTU), a flow computer, or any combination thereof. In still another embodiment, the emissions tracking software is configured to generate an amount of applicable emissions credits based on the equivalent methane emissions output quantity. In another embodiment, the pressure measurement of the air is measured by a pressure sensor operatively connected to the air compressor and the controller, where the pressure sensor is configured to transmit the pressure measurement of the air to the controller. In still another embodiment, the temperature measurement of the air is measured by a temperature sensor and the temperature sensor is configured to transmit the temperature measurement of the air to the controller. In yet another embodiment, the measured flow rate is a raw measurement of the flow of compressed air transmitted by the air compressor in cubic feet per minute. In another embodiment, the controller is configured to calculate the compensated air flow volume based on effects associated with Boyle's Law, Charles' Law, or both.

### BRIEF DESCRIPTION OF THE DRAWINGS

Further features and advantages can be ascertained from the following detailed description that is provided in connection with the drawings described below:

FIG. 1 is a schematic illustration of a traditional wellhead system having a pneumatic control system powered by natural gas.

FIG. 2 is a schematic illustration of a system for determining emissions savings from operating a compressed air-powered pneumatic system in accordance with one embodiment of the present disclosure.

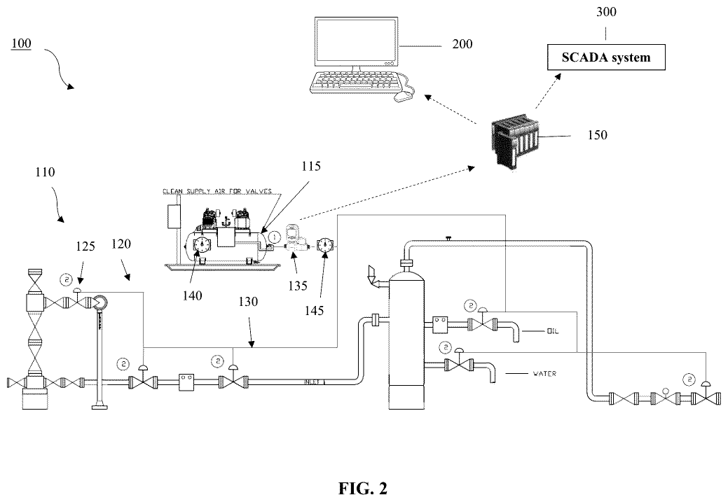

FIG. 3 is a schematic diagram of a computing device for use with the present systems and methods according to one embodiment of the present disclosure.

FIG. 4 is a schematic diagram of a SCADA system according to one embodiment of the present disclosure.

### DETAILED DESCRIPTION

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first,” “second,” “third,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Spatially relative terms, such as “above,” “under,” “below,” “lower,” “over,” “upper,” and the like, may be used herein for ease of description to describe one element or feature's relationship to another when the apparatus is right side up as shown in the accompanying drawings.

It is to be understood that any given element of the disclosed embodiments of the invention may be embodied in a single structure, a single step, a single substance, or the like. Similarly, a given element of the disclosed embodiment may be embodied in multiple structures, steps, substances, or the like.

The present disclosure provides systems and methods for determining, in real-time, emissions savings. In one embodiment, the systems and methods of the present disclosure are configured to determine emissions savings achieved by converting natural gas-powered pneumatic control systems to compressed instrument air systems. In this embodiment, because instrument air systems substitute compressed air for pressurized natural gas, the systems and methods are configured to determine an amount of methane emissions savings by calculating, in real-time, the amount of compressed air used by a pneumatic system and converting the amount of compressed air into an equivalent amount of methane emissions that would have been emitted into the atmosphere had the pneumatic system been operated by natural gas.

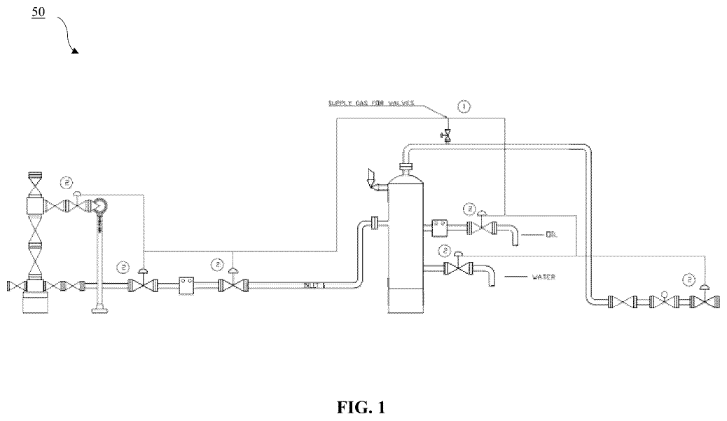

Referring to FIG. 1, a schematic diagram of a system 100 for determining emissions savings according to one embodiment of the present disclosure is illustrated. The system 100 is intended for use with a compressed air-powered pneumatic system 110. As used herein, “compressed air” is defined as free air that has been compressed into a volume that is smaller than the volume the air normally occupies at normal atmospheric pressure. Controlled expansion of the compressed air can be used as a source of power to operate a wide range of pneumatically powered valves and tools. The compressed air-powered pneumatic system 110 includes an air compressor 115 operatively connected to a pneumatically operated valve 125 that regulates the flow of a fluid, such as water, oil, gas, or steam, in a pipeline 130. Compressed air is supplied from the air compressor 115 and piped through a distribution system 120, which is comprised of the pipeline 130, to the pneumatically operated valve 125. The pneumatically operated valve 125 includes a controllable valve element (not shown) disposed to selectively regulate the flow of the fluid through the pipeline 130. The controllable valve element in the pneumatically operated valve 125 uses the power of the compressed air to open, close, or regulate the flow of the fluid within the pipeline 130. In some embodiments, the air compressor 115 is powered by electric power (for example, the air compressor 115 is AC powered). In further embodiments, the air compressor 115 is DC solar powered.

As shown in FIG. 1, the compressed air-powered pneumatic system 110 includes six pneumatically operated valves 125. However, any number of pneumatically operated valves may be used with the system of the present disclosure. For instance, the compressed air-powered pneumatic system 100 may include a single pneumatically operated valve 125 or a plurality of pneumatically operated valves 125. In addition, more than one air compressor 115 may be used with the system of the present disclosure.

The compressed air-powered pneumatic system 110 also includes a flow measurement device 135. In some embodiments, the flow measurement device 135 is a device configured to measure a mass or volume flow rate of the compressed air passing through the distribution system 120. The flow measurement device 135 is operatively connected to the pipeline 130 such that the flow measurement device 135 can precisely and accurately measure the flow rate of the compressed air. The flow measurement device 135 may measure the flow rate of the compressed air upstream of the pneumatically operated valve 125. In other embodiments, the flow measurement device 135 may measure the flow rate of the compressed air downstream of the pneumatically operated valve 125.

In some embodiments, the flow measurement device 135 is a flow meter. For example, the flow measurement device 135 may be a mass flow meter that provides for precise measurement of gas mass flow. In another embodiment, the flow measurement device 135 may be a volumetric flow meter. Mass flow rate measures mass per unit time, differing from volumetric flow rate—which measures volume per unit time. In further embodiments, the flow measurement device 135 may be an ultrasonic flow meter capable of detecting the velocity of a flow in a calibrated tube through doppler shift or time of flight type measurements. In still further embodiments, the flow measurement device 135 may be a pressure differential type, a Coriolis type, a vortex shedding type, a hot wire type, or any other type of flow meter known in the art.

In further embodiments, the compressed air-powered pneumatic system 110 may also include a pressure sensor 140 and a temperature sensor 145. The pressure sensor 140 is configured to measure the pressure of the compressed air passing through the distribution system 120 while the temperature sensor 145 is configured to measure the temperature of the compressed air. In some embodiments, the pressure sensor 140 is operatively connected to the air compressor 115 to measure the pressure of the compressed air precisely and accurately. In further embodiments, the temperature sensor 145 is operatively connected to the pipeline 130 such that the temperature sensor 145 can precisely and accurately measure the temperature of the compressed air.

A controller 150 is operatively and communicatively coupled to the air compressor 115 as well as the flow measurement device 135, the pressure sensor 140, and the temperature sensor 145. The controller 150 receives and interprets system information from the air compressor 115, the flow measurement device 135, the pressure sensor 140, and the temperature sensor 145. The controller 150 may be any controller that conforms to IEC61131.5 programming language and includes a Modbus interface.

In some embodiments, the controller 150 may be a programmable logic controller (PLC), a flow computer, or a remote telemetry unit (RTU). In one embodiment, the controller 150 is a programmable logic controller (PLC). A PLC is a specialized computer control system configured to execute software which continuously gathers data on the state of input devices to control the state of output devices. A PLC typically includes a processor (which may include volatile memory), volatile memory including an application program, and one or more input/output (I/O) ports for connecting to other devices in the automation system. The PLC can be paired with Human Machine Interface (HMI) or Supervisory, Control and Data Acquisition (SCADA) systems. In further embodiments, the controller 150 is a remote telemetry unit (RTU). A RTU is a device that is used for remote monitoring and control of field devices within an automated industrial process. The RTU may be used to store and transmit flow information as part of a remote SCADA network. In still further embodiments, the controller 150 may be a PLC module providing an integrated PLC, RTU, and flow computer solution. In this embodiment, the flow computer module can use its onboard, high-speed processor for flow calculations and memory for data archiving. The module can read the input information (flow meter, pressure, temperature, etc.) directly from the PLC over its high-speed backplane. The archived data within the flow computer module's memory is available to the SCADA network via the Modbus protocol.

In one embodiment, the controller 150 is configured to interpret an operational status of the air compressor 115. In this embodiment, the controller 150 is communicatively coupled to the air compressor 115 and monitors the operational status of the air compressor 115 as being active, i.e., the air compressor 115 is turned on and transmitting compressed air, or inactive, i.e., the air compressor 115 is either turned off or turned on and not transmitting compressed air. The controller 150 monitors the operational status of the air compressor 115 over a predetermined time period. That is, the monitoring can be performed hourly, daily, weekly, monthly, yearly, or at any other known interval. Alternatively, the monitoring can be performed randomly. In some embodiments, the controller 150 monitors and tracks the operational status of the air compressor 115 hourly. In further embodiments, the controller 150 monitors and tracks the operational status of the air compressor 115 daily. In still further embodiments, the controller 150 monitors and tracks the operational status of the air compressor 115 monthly. In yet further embodiments, the controller 150 monitors and tracks the operational status of the air compressor 115 yearly.

The flow measurement device 135 is configured to transmit a flow signal indicative of the measured flow rate to the controller 150. The term, “measured flow rate,” as used herein, refers to a raw measurement of the flow of compressed air transmitted by the air compressor 115 in cubic feet per minute (cu ft/min or CFM). Based on the measured flow rate, the controller 150 can calculate, in real time, a compensated air flow volume based on changes in temperature and/or pressure conditions. In some embodiments, the controller 150 is configured to receive the measured flow rate from the flow measurement device 135 and calculate, in real time, a compensated air flow volume based on one or more correction factors. The term, “compensated air flow volume,” as used herein, refers to a measurement of the total amount of compressed air transmitted by the air compressor 115 after one or more correction factors have been applied. In one embodiment, the compensated air flow volume may incorporate a correction factor for changes in temperature of the compressed air flowing through the pipeline 130. In another embodiment, the compensated air flow volume may incorporate a correction factor for changes in pressure of the compressed air flowing through the pipeline 130. In still another embodiment, the compensated air flow volume may incorporate correction factors for changes in both temperature and pressure of the compressed air flowing through the pipeline 130.

In this embodiment, the controller 150 is configured to receive, in real time, pressure measurements from the pressure sensor 140 and/or temperature measurements from the temperature sensor 145. Using the pressure and/or temperature measurements, the controller 150 can generate the compensated air flow volume that has been corrected for pressure and/or temperature conditions. In one embodiment, the controller 150 may operate to account for the effects associated with Boyle's Law and/or Charles' Law. For example, given that a rate of volumetric flow will change with changes in temperature and pressure, any volumetric flow rate with a known gas composition and known reference conditions can be compensated to a differing set of reference conditions. This compensation can be approximated using the combined gas law that incorporates Boyle's law, Charles' law, and Amonton's law:

$$\frac{pV}{T} = k$$

where p is the pressure, V is the volume, T is the absolute temperature (in units of K), and k is a constant. To apply this equation to gas flow compensation, it can be used in the following form:

$$\frac{{p}_{1} {V}_{1}}{{T}_{1}} = \frac{{p}_{2} {V}_{2}}{{T}_{2}}$$

As such, the equation provided above can be used by the controller 150 to calculate the compensated air flow volume. The compensated air flow volume over a predetermined time period (for example, a day, month, or year) represents the total amount of compressed air used by the compressed air-powered pneumatic system 110 within the predetermined time period.

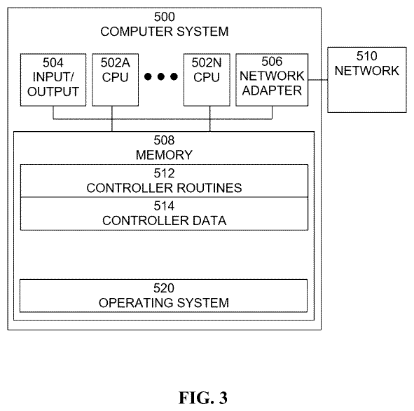

In some embodiments of the present disclosure, the controller 150 includes a computing device 500, as shown in FIG. 3. In another embodiment, the controller 150 is communicatively coupled to the computing device 500. The computing device 500 may be implemented using one or more programmed general-purpose computer systems, such as embedded processors, systems on a chip, personal computers, workstations, server systems, and minicomputers or mainframe computers, or in distributed, networked computing environments. The computing device 500 may include one or more processors (CPUs) 502A-502N, input/output circuitry 504, network adapter 506, and memory 508. CPUs 502A-502N execute program instructions to carry out the functions of the present systems and methods. Typically, CPUs 502A-502N are one or more microprocessors, such as an INTEL CORE® processor.

Input/output circuitry 504 provides the capability to input data to, or output data from, the computing device 500. For example, input/output circuitry 504 may include input devices, such as a graphical user interface, keyboards, mice, touchpads, trackballs, scanners, and analog to digital converters; output devices, such as display screens, video adapters, monitors, and printers; and input/output devices, such as modems.

Network adapter 506 interfaces the computing device 500 with a network 510. Network 510 may be any public or proprietary data network, such as LAN and/or WAN (for example, the Internet). Memory 508 stores program instructions that are executed by, and data that are used and processed by, CPU 502 to perform the functions of the computing device 500. Memory 508 may include, for example, electronic memory devices, such as random-access memory (RAM), read-only memory (ROM), programmable read-only memory (PROM), electrically erasable programmable read-only memory (EEPROM), and flash memory, and electro-mechanical memory, which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, or Serial Advanced Technology Attachment (SATA), or a variation or enhancement thereof, or a fiber channel-arbitrated loop (FC-AL) interface.

Memory 508 may include controller routines 512, controller data 514, and operating system 520. Controller routines 512 may include software routines to perform processing to implement one or more controllers. Controller data 514 may include data needed by controller routines 512 to perform processing. For example, controller routines 512 may include software for analyzing incoming data from the controller 150. In some embodiments, controller routines 512 may include software for generating the compensated air flow volume based on the pressure and/or temperature measurements received from the pressure sensor 140 and/or temperature sensor 145.

In one embodiment, controller routines 512 on the computing device 500 include software for converting the compensated air flow volume into an equivalent emission output quantity. For example, in one embodiment, because the compressed air-powered pneumatic system 110 substitutes compressed air for pressurized natural gas, the total amount of compressed air used by the compressed air-powered pneumatic system 110 can be converted into an equivalent methane emission output quantity, which represents the amount of methane that would have been emitted into the atmosphere had the pneumatic system been operated by natural gas. In further embodiments, the total amount of compressed air used by the compressed air-powered pneumatic system 110 can be converted into an equivalent carbon emission output quantity, which represents the amount of carbon dioxide that would have been emitted into the atmosphere had the pneumatic system been operated by natural gas. The software can be integrated with any known equation or calculation for determining an equivalent emission output quantity from the total compensated air flow volume for a desired time period. For example, to determine an equivalent methane emission output quantity, the total compensated air flow volume in cubic feet per minute can be converted into tons of methane.

The calculated emission output quantity can be entered and stored in an emission source database on the computing device 500. In this embodiment, the emission source database can store data related to the compensated air flow volume and the calculated emission output quantity, including the time period associated with each output quantity, emission source identifying information, historical emissions data, and site information. The emissions information can be collected and/or entered into the emission source database on a periodic basis.

In further embodiments, controller routines 512 on the computing device 500 include software for generating a quantity of emissions credits from the emission output quantity. In one embodiment, the emission output quantity can be used to generate a total amount of emissions credits, as determined by applicable standards promulgated by governmental agencies. For instance, the tons of methane saved by utilizing the compressed air-powered pneumatic system 110 can be converted into applicable emissions credits. The emission output quantity can also be used to calculate fines saved by reducing emissions. For example, the tons of methane saved by utilizing the compressed air-powered pneumatic system 110 can be used to calculate potential fines saved under the Methane Emissions Reduction Act (MERP).

In some embodiments, controller routines 512 on the computing device 500 can also include software for providing predictive analysis of emissions savings by tracking and analyzing historical data related to the compensated air flow volume and the emission output quantities of a particular compressed air-powered pneumatic system 110. The software can draw upon the calculations discussed above to predict future trends in the emissions savings data. A user can then utilize a predicted trend and the above information to take appropriate steps to address any predicted impact of the trend.

In still further embodiments, the system 100 of the present disclosure includes a human-machine interface (HMI) 200. An HMI is a user interface or dashboard that connects a person to a machine, system, or device. In one embodiment, the HMI 200 communicates with the controller 150 to receive and display information related to the compressed air-powered pneumatic system 110. For instance, the HMI 200 can be used to visually display, track, and/or monitor data relating to the measured flow rate, the pressure measurements, the temperature measurements, and the compensated air flow volume calculations. In still other embodiments, the HMI 200 may be used to visually display, track, and/or monitor the equivalent emission output quantity of the compressed air-powered pneumatic system 110 and the quantity of emissions credits.

In further embodiments, the system 100 also includes a system for supervisory control and data acquisition (SCADA) 300. SCADA systems are frequently used to monitor and control industrial equipment and processes in such industries as oil and gas production, manufacturing, energy production, transportation, and the like. The SCADA system 300 can be used to gather data in real time from the controller 150 so that the data can be presented in a timely manner.

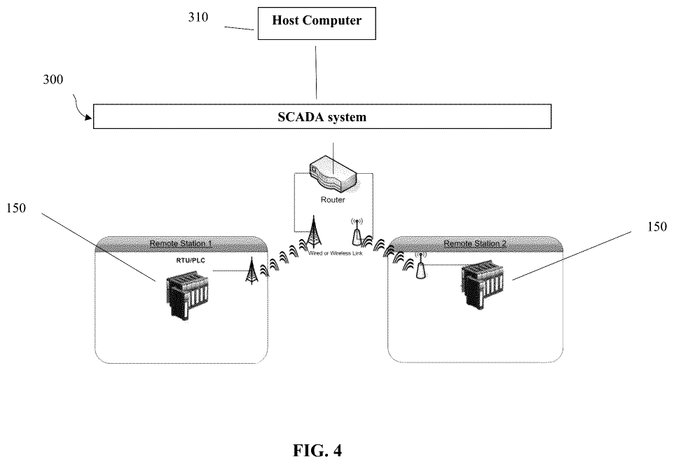

FIG. 4 shows a schematic diagram of the SCADA system 300 according to one embodiment of the present disclosure. The SCADA system 300 includes various SCADA devices affiliated with one or more sensors, control devices, or other field instrumentation for gathering data. The SCADA devices may include, for instance, the flow measurement device 135, the pressure sensor 140, the temperature sensor 145, and the pneumatically operated valves 125. Data observed from the various SCADA devices is provided to the controller 150. The controller 150 can communicate with one or more host computers 310, such as data acquisition servers and engineering/operation workstations, through a distributed communication network. In some embodiments, the archived data within the memory of the controller 150 is available to the SCADA network via the Modbus protocol.

The systems of the present disclosure may also be used to determine carbon emissions savings achieved by using solar-powered air compressors instead of conventional AC electric powered air compressors. In this embodiment, the systems described above can be used to not only determine methane emissions savings, but also carbon emissions savings from operating a solar-powered compressed air pneumatic system. The system operates in a manner similar to the systems described above; however, in this embodiment, the air compressor 115 is operated by solar energy (rather than conventional AC electric power) and the controller 150 is configured to calculate a solar power output of the air compressor 115 while it is active. The term, “solar power output,” as used herein, refers to the total electricity consumption in kilowatt hours of the air compressor. The computing device 500 can include software to convert the solar power output to an equivalent carbon emission output quantity, which represents the amount of carbon dioxide emissions saved by utilizing a solar-powered air compressor 115 instead of an electric powered air compressor. The computing device 500 can also include software that generates a quantity of carbon emissions savings based on the equivalent carbon emission output quantity.

In further embodiments, the present disclosure provides methods for determining methane and/or carbon emissions savings from operating a compressed air-powered pneumatic system. In one embodiment, for determining methane emissions savings, the method includes measuring, with the flow measurement device 135, a flow rate of air transmitted by the air compressor 115 and calculating a compensated air flow volume based on the measured flow rate and at least one or both of a temperature measurement or a pressure measurement of the air provided by the temperature sensor 145 and the pressure sensor 140, respectively. The method further includes transmitting the compensated air flow volume to the computing device 500 where the computing device 500 includes emissions tracking software configured to convert the compensated air flow volume to an equivalent methane emissions output quantity and generate, using the methane emissions output quantity, a quantity of methane emissions savings.

In embodiments for determining carbon emissions savings, the method may further include calculating, in real time, a solar power output for a period of time the air compressor 115 is active and transmitting the solar power output to the computing device 500 where the computing device 500 includes emissions tracking software configured to convert the solar power output to an equivalent carbon emissions output quantity and generate, using the equivalent carbon emissions output quantity, a quantity of carbon emissions savings.

The methods and systems described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the systems and methods in addition to those shown and described herein will become apparent to those skilled in the art from the foregoing description. Such modifications are also intended to fall within the scope of the disclosure. All patents and patent applications cited in the foregoing text are expressly incorporated herein by reference in their entirety. Any section headings herein are provided only for consistency with the suggestions of 37 C.F.R. § 1.77 or otherwise to provide organizational queues. These headings shall not limit or characterize the invention(s) set forth herein.

What is claimed is:

1. A system for determining methane emissions savings from operating a compressed air-powered pneumatic system, the system comprising:
an air compressor configured to transmit air through a conduit;
a flow measurement device operatively connected to the conduit, wherein the flow measurement device is configured to measure a flow rate of the air transmitted by the air compressor;
a controller operatively connected to the air compressor and the flow measurement device, wherein the controller comprises software configured to calculate, in real time, a compensated air flow volume based on the measured flow rate and at least one or both of a temperature measurement or a pressure measurement of the air; convert the compensated air flow volume to a methane emissions output quantity; and generate, using the methane emissions output quantity, a quantity of methane emissions savings.

2. The system of claim 1, wherein the controller is a programmable logic controller (PLC), a remote telemetry unit (RTU), a flow computer, or any combination thereof.

3. The system of claim 1, wherein the flow measurement device is a flow meter.

4. The system of claim 1, wherein the controller is configured to calculate the compensated air flow volume based on effects associated with Boyle's Law, Charles' Law, or both.

5. The system of claim 1, further comprising a pressure sensor operatively connected to the air compressor and the controller, wherein the pressure sensor is configured to transmit the pressure measurement of the air to the controller.

6. The system of claim 1, further comprising a temperature sensor operatively connected to the conduit and the controller, wherein the temperature sensor is configured to transmit the temperature measurement of the air to the controller.

7. A system for determining methane and carbon emissions savings from operating a solar-powered compressed air pneumatic system, the system comprising:
an air compressor configured to transmit air through a conduit, wherein the air compressor is powered by solar energy;
a flow measurement device operatively connected to the conduit, wherein the flow measurement device is configured to measure a flow rate of the air transmitted by the air compressor;
a controller operatively connected to the air compressor and the flow measurement device, wherein the controller is configured to calculate, in real time, (i) a compensated air flow volume based on the measured flow rate and at least one or both of a temperature measurement or a pressure measurement of the air, and (ii) a solar power output; and
a computing device communicatively coupled to the controller, wherein the computing device comprises emissions tracking software configured to:
convert the compensated air flow volume to an equivalent methane emissions output quantity;
convert the solar power output to an equivalent carbon emissions output quantity; and
generate, using the equivalent methane and carbon emissions output quantities, a quantity of methane emissions savings and a quantity of carbon emissions savings.

8. The system of claim 7, wherein the controller is a programmable logic controller (PLC), a remote telemetry unit (RTU), a flow computer, or any combination thereof.

9. The system of claim 7, wherein the flow measurement device is a flow meter.

10. The system of claim 7, further comprising a pressure sensor operatively connected to the air compressor and the controller, wherein the pressure sensor is configured to transmit the pressure measurement of the air to the controller.

11. The system of claim 7, further comprising a temperature sensor operatively connected to the conduit and the controller, wherein the temperature sensor is configured to transmit the temperature measurement of the air to the controller.

12. The system of claim 7, further comprising a human-machine interface (HMI) operatively connected to the controller, the computing device, or both.

13. A method for determining methane emissions savings from operating a compressed air-powered pneumatic system, the method comprising:
measuring a flow rate of air transmitted by an air compressor;
calculating a compensated air flow volume based on the measured flow rate and at least one or both of a temperature measurement or a pressure measurement of the air;
transmitting the compensated air flow volume to a computing device, wherein the computing device comprises emissions tracking software configured to:
convert the compensated air flow volume to an equivalent methane emissions output quantity; and
generate, using the methane emissions output quantity, a quantity of methane emissions savings.

14. The method of claim 13, wherein the measuring step is performed with a flow meter.

15. The method of claim 13, wherein the calculating step is performed with a controller comprising a programmable logic controller (PLC), a remote telemetry unit (RTU), a flow computer, or any combination thereof.

16. The method of claim 13, wherein the emissions tracking software is configured to generate an amount of applicable emissions credits based on the equivalent methane emissions output quantity.

17. The method of claim 15, wherein the pressure measurement of the air is measured by a pressure sensor operatively connected to the air compressor and the controller, wherein the pressure sensor is configured to transmit the pressure measurement of the air to the controller.

18. The method of claim 15, wherein the temperature measurement of the air is measured by a temperature sensor and the temperature sensor is configured to transmit the temperature measurement of the air to the controller.

19. The method of claim 13, wherein the measured flow rate is a raw measurement of the flow of compressed air transmitted by the air compressor in cubic feet per minute.

20. The method of claim 15, wherein the controller is configured to calculate the compensated air flow volume based on effects associated with Boyle's Law, Charles' Law, or both.
